(19) United States
(12) Patent Application Publication
(10) Pub. No.: US 2007/0038542 A1
(43) Pub. Date: Feb. 15, 2007

(54) SYSTEM AND METHOD FOR EVALUATING THE PERFORMANCE OF A RETIREMENT PLAN

(75) Inventors: Ward Armstrong, Eden Prairie, MN (US); John Baker, Eden Prairie, MN (US); Rusty Field, Plymouth, MN (US); Annette G. Jenson, St. Anthony, MN (US); Kellie Richter, Maple Grove, MN (US); Todd Wold, Andover, MN (US); Darcy Zimbrick, Maplewood, MN (US); Sharon L. Hughes, Minneapolis, MN (US)

Correspondence Address: Myra T. Askins-Sullivan;Kennedy Covington Lobdell & Hickman, L.L.P., Hearst Tower, 47th Floor, 214 North Tryon Street, Charlotte, NC, 28202, US

(73) Assignee: AMERIPRISE FINANCIAL, INC., Minneapolis, MN (US)

(21) Appl. No.: 11/276,006

(22) Filed: Feb. 9, 2006

Related U.S. Application Data
(60) Provisional application No. 60/707,680, filed on Aug. 12, 2005.

(51) Int. Cl. G06Q 40/00

(52) U.S. Cl. 705/36 R

(57) ABSTRACT

A system, method and computer program product provide the sponsor of a retirement plan with an objective measure of the overall performance of the retirement plan. By determining the values of certain well-defined parameters, illustrated embodiments provide the sponsor with a detailed view of the operation of the retirement plan, including levels of participation, levels of contributions being made, projected levels of income replacement once the participants eventually retire, etc. There are also determined, from these values, additional parameter values that provide the sponsor with a compact, yet rigorous, overall view of whether the retirement plan is performing in a manner consistent with meeting the goals of the retirement plan.

### CROSS-REFERENCE TO RELATED APPLICATION

This application claims priority to, and the benefit of, provisional application No. 60/707,680, filed Aug. 12, 2005, the entire disclosure of which is incorporated herein by reference.

### FIELD OF THE INVENTION

The present invention generally relates to computer-assisted analysis of a pension or other retirement plan to help the sponsor of the plan evaluate whether the plan is meeting its goals and to devise remedies for any shortcomings that may be identified.

### BACKGROUND OF THE INVENTION

In the past, company pension programs were most frequently defined benefits programs, in which each retiree covered by the plan could expect to receive periodic (e.g., monthly) payments of a pre-specified amount, the amount being determined, typically, by the retiree's salary history, total years of service, etc. More recently, many companies have closed their defined benefit plans to new employees, and have created defined contribution plans for the latter. In addition, many employers now provide, as at least a part of their retirement system, the ability for employees to open 401(k) accounts using tax-sheltered income.

In both 401(k) plans and defined contribution plans, as is well known, the amount the employee will ultimately receive as a periodic payment after retirement is determined chiefly or entirely by the contributions made by the employee and by the company to the plan, and by results obtained from investments made with the amounts in the employee's account prior to (and after) retirement. In such plans, the employee has a high degree of control over what types of investments are made, and over how much of the amount available for investment is actually placed in the various types of investments that are available. Thus, in such a plan, the responsibility for good management of the account, and for the benefits that are ultimately obtained by the employee after retirement, shifts from the employer to the employee.

Most employees, however, are not trained in portfolio management. To assist individual investors, there are software tools by means of which an investor can make projections of future performance of existing investments, although of course such projections must be based on assumptions made by the investor about future rates of return, future rates of inflation and the like. While an employee participating in a 401(k) or a defined contribution plan can utilize such tools as part of managing the employee's account, not all employees will actually do so, nor does every employee have the investment expertise to formulate the appropriate and realistic assumptions that are key to making effective use of such tools.

Moreover, even if it happens that a large percentage of the employees of a given employer are fairly active in managing their accounts, the employer is not readily able to judge what proportion of the employees are doing sufficiently well with those accounts to be able to retire when desired and at the desired level of income. As a result, the employer may not be as well informed as they would like as to how well the retirement plan is performing. Should the employer become aware that the retirement plan is not performing as the employer would like it to do, the employer can only speculate as to the reasons for the problem, and does not have the means to identify those reasons clearly, or to formulate solutions.

Given the foregoing, what is needed is a system, method and computer program product which allows a retirement plan sponsor, in a disciplined and methodical fashion, to evaluate how well the plan as a whole is performing, identify specific situations that may tend to impede the plan from meeting its goals in some respect, and suggest possible solutions for such situations.

### BRIEF DESCRIPTION OF THE INVENTION

The present invention meets the above-identified needs by providing a system, method and computer program product for evaluating the performance of a retirement plan.

One advantage of the present invention is that it provides the sponsor of a retirement plan with an objective measure of the overall performance of the retirement plan. By determining the values of certain well-defined parameters, the present invention provides the sponsor with a detailed view of the activities of the retirement plan, including levels of participation, levels of contributions being made, projected levels of income replacement once the participants eventually retire, etc. The present invention also determines, from these values, additional parameter values that provide the sponsor with a compact, yet rigorous, overall view of whether the retirement plan is performing in a manner consistent with meeting the goals of the retirement plan.

Another advantage of the present invention is that it provides the sponsor with the ability, subject to the availability of the necessary data, to take into account plan participants' existing entitlements to Social Security benefits. Additionally, some employees may have vested rights in one or more other retirement plans, individual retirement accounts (IRAs), or other types of retirement accounts, and these additional benefits and assets can be taken into account to evaluate whether the retirement plan is likely to meet its goals of helping employees to achieve retirement at the desired levels of income.

Another advantage of the present invention is that it pinpoints areas of possible concern to the plan sponsor, as the first step in helping the sponsor to devise and execute steps to improve performance if such appears to be necessary. In particular, the present invention enables the plan sponsor to conclude, in an appropriate case, that a perceived deficiency in performance is due to the structure and features of the existing retirement plan itself, and thus suggests to the sponsor that a change in the retirement plan should be considered.

Another advantage of the present invention is that it enables the plan sponsor to set employees on the right course to obtain acceptable results after retirement, by means of focused educational efforts.

Another advantage of the present invention is that the implementation of focused educational efforts directed to participants and potential participants makes visible the plan sponsor's interest in and commitment to seeing the retirement plan achieve its goals. This, in addition to actual improvements in the performance of the retirement plan through use of the present invention, raises employees' (and prospective employees') confidence in the retirement plan.

Further features and advantages of the present invention as well as the structure and operation of various embodiments of the present invention are described in detail below with reference to the accompanying drawings.

### BRIEF DESCRIPTION OF THE DRAWINGS

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a system diagram of an exemplary system in which the present invention, in an embodiment, would be implemented.

FIG. 2 is a flowchart illustrating a process in which the present invention could advantageously be utilized.

FIG. 3A is a flowchart illustrating an evaluative and improvement process according to one embodiment of the present invention, and FIG. 3B is a flowchart showing a portion of that process in detail.

FIGS. 4 through 20 are examples of portions of reports produced by using an embodiment of the invention (these may take the form of screens or windows, but may also be produced as hard print-out).

### DETAILED DESCRIPTION

Overview

The present invention is directed to a system, method and computer program product for analysis of a pension or other retirement plan to help the sponsor of the plan evaluate whether the plan is meeting its goals and to devise remedies for any shortcomings that may be identified.

The present invention is now described in more detail herein in terms of the above exemplary system. This is for convenience only and is not intended to limit the application of the present invention. In fact, after reading the following description, it will be apparent to one skilled in the relevant art(s) how to implement the following invention in alternative embodiments.

The terms “employer”, “plan sponsor” and “sponsor” and/or the plural form of these terms are used interchangeably throughout herein to refer to those persons or entities capable of accessing, using, being affected by and/or benefiting from the tool that the present invention provides for evaluating the performance of a retirement plan.

System

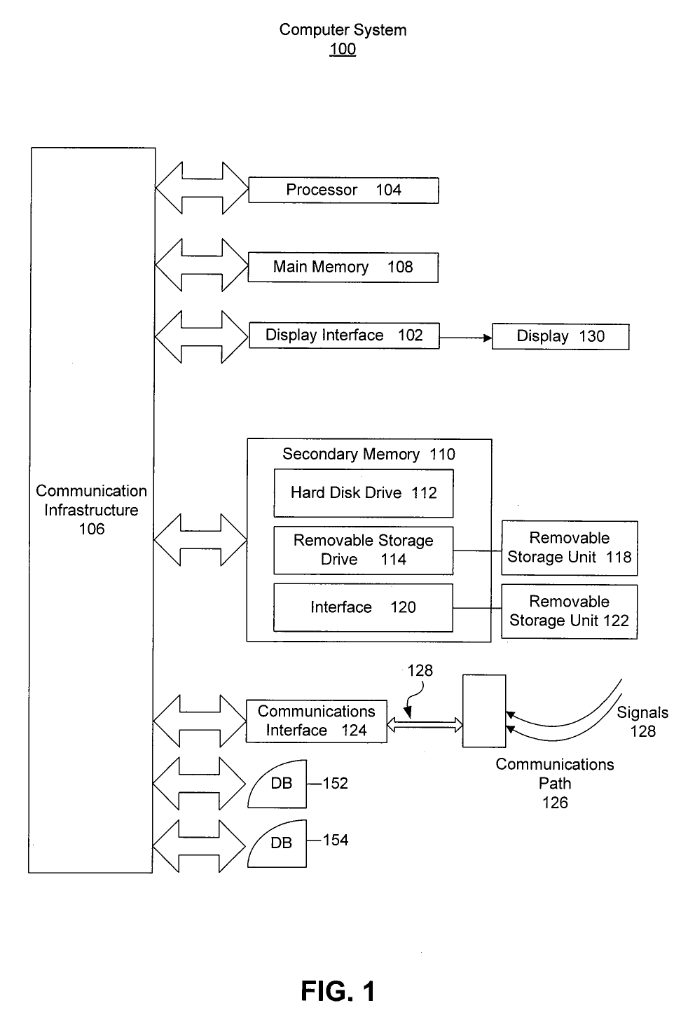

Referring to FIG. 1, a system diagram of an exemplary system 100 in which the present invention, in an embodiment, would be implemented is shown.

In this embodiment, the invention is directed toward one or more computer systems capable of carrying out the functionalities described herein. An example of a computer system 100 is shown in FIG. 1.

The computer system 100 includes one or more processors, such as a processor 104. Processor 104 is connected to communication infrastructure 106 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 100 can include a display interface 102 that forwards graphics, text, and other data from communication infrastructure 106 (or from a frame buffer not shown) for display on a display unit 130.

Computer system 100 also includes suitable main (working) memory 108, preferably random access memory (RAM), and suitable secondary (non-volatile) memory 110. Secondary memory 110 may include, for example, a hard disk drive 112 and/or a removable storage drive 114, representing a floppy disk drive, a magnetic tape drive, an optical disk drive, etc. The removable storage drive 114 reads from and/or writes to a removable storage unit 118 in a well known manner. Removable storage unit 118 represents a floppy disk, magnetic tape, optical disk, etc., which is read by and written to by removable storage drive 114. As will be appreciated, the removable storage unit 118 includes a computer usable storage medium having stored therein computer software and/or data.

Additionally or alternatively, secondary memory 110 may include other similar devices for allowing computer programs or other instructions to be loaded into computer system 100. Such devices may include, for example, a removable storage unit 122 and an interface 120. Examples of such may include a program cartridge and cartridge interface (such as that found in video game devices), a removable memory chip (such as an erasable programmable read only memory (EPROM), or programmable read only memory (PROM)) and associated socket, and other removable storage units such as 122 and interfaces such as 120, which allow software and data to be transferred from removable storage unit(s) 122 to computer system 100.

Computer system 100 may also include a communications interface 124. Communications interface 124 allows software and data to be transferred between computer system 100 and external devices. Examples of communications interface 124 may include a modem, a network interface (such as an Ethernet card), a communications port, a Personal Computer Memory Card International Association (PCMCIA) slot and card, etc. Software and data transferred via communications interface 124 are in the form of signals 128 which may be electronic, electromagnetic, optical or other signals capable of being received by communications interface 124. These signals 128 are provided to communications interface 124 via a communications path (e.g., channel) 126. This channel 126 carries signals 128 and may be implemented using wire or cable, fiber optics, a telephone line, a cellular link, a radio frequency (RF) link and other communications channels.

Server 102 may include any hardware and/or software suitably configured to facilitate communications between the various system components as discussed herein. Further, server 102 may be configured to transmit data to and from computing system 104 within markup language documents. Server 102 may operate as a single entity in a single geographic location or as separate computing components located together or in separate geographic locations. Requests originating from computing system 104 may pass through a firewall prior to being received and processed at server 102. As used herein, “transmit” may include sending electronic data from one system component to another over a network connection. Additionally, as used herein, “data” may include encompassing information such as commands, queries, files, data for storage, and the like in digital or any other form. Server 102 may provide a suitable web site or other Internet-based graphical user interface elements which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, ORACLE, SYBASE, INFORMIX MySQL, InterBase, etc., may be used to provide an Active Data Object (ADO) compliant database management system.

In this document, the terms “computer program medium” and “computer usable medium” are used to generally refer to media such as removable storage drive 114, a hard disk installed in hard disk drive 112, and signals 128. These computer program products provide software to computer system 100. The invention is directed to such computer program products, among other embodiments.

Processor 104 performs the processing of information required in the performance of the method of the present invention. In addition, computer system 100 includes a user interface by means of which the performance of the method of the invention is initiated and controlled. The user interface may include display 130, as well as a keyboard, a mouse or other pointing device, etc.

As can be seen from FIG. 1, processor 104 obtains data from one or more databases. For example, one database 152 contains detailed financial information about the individual accounts in the retirement plan, including current account balance, the current investments of the balance of each account, the rate at which the participant is making contributions, the rate at which the employer is making contributions (if any), the history of transactions in the account, etc. A second database 154 contains personnel information about the employees who are participating in, or who are eligible to participate in, the retirement plan, including information about each employee's age, tenure with the company, salary history, etc. While this information can be obtained from live databases, it is also contemplated that the information would be copied in advance from the plan sponsor's and/or trustee's databases for use in the present invention, in the interest of improving processing speed, as well as of database security. Another alternative is to construct a dedicated database that accommodates all the information required to carry out the present invention, by importing the information from the various databases in which it is normally stored.

Although the above discussion may identify particular types of databases, a person of skill in the relevant art(s) will appreciate that the databases discussed herein may be of any type such as, for example, relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of the invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN. 1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the invention by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments of the invention, the data can be stored without regard to a common format. However, in one exemplary embodiment of the invention, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a standalone interaction device configured to create, update, delete or augment the data in accordance with the header or trailer. As such, in one embodiment, the header or trailer is not stored on the transaction device along with the associated issuer-owned data but instead the appropriate action may be taken by providing to the transaction instrument user at the standalone device, the appropriate option for the action to be taken. The invention may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the invention may consist of any combination thereof at a single location or at multiple locations, wherein each database or system includes any of various suitable security features, such as firewalls, access codes, encryption, decryption, compression, decompression, and/or the like. For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The invention may be described herein in terms of functional block components, screen shots, optional selections and various processing steps. It should be appreciated that such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, the software elements of the invention may be implemented with any programming or scripting language such as C, C++, JAVA, COBOL, assembler, PERL, Visual Basic, SQL Stored Procedures, extensible markup language (XML), with the various algorithms being implemented with any combination of data structures, objects, processes, routines or other programming elements. Further, it should be noted that the invention may employ any number of conventional techniques for data transmission, signaling, data processing, network control, and the like. Still further, the invention could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, prompts and the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Process

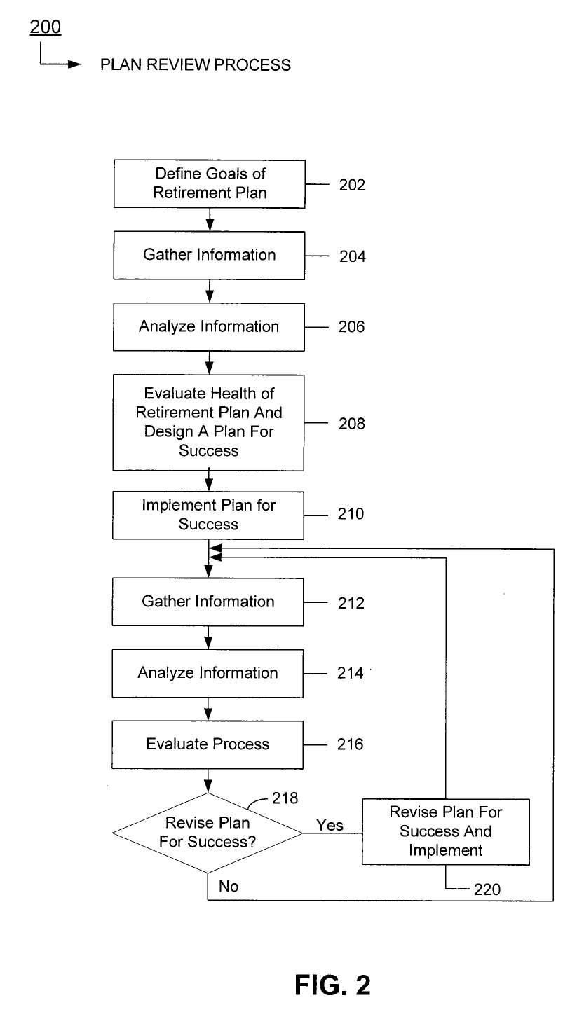

Referring to FIG. 2, a flowchart illustrating a plan-review process 200, in which the present invention is advantageously applied, is shown.

Process 200 begins at step 202, in which the sponsor defines the goals it hopes to meet using the retirement plan. This may be done by the sponsor itself, or on the sponsor's behalf by outside experts in consultation with the sponsor. While these goals are defined by the plan sponsor, and thus can be expected to vary somewhat from one sponsor to another, the goals will typically include one or more of the following, possibly with modifications.

First, it will normally be a goal that each participant will, ideally, have a sufficient account balance by expected retirement age to be able to provide that participant with a comfortable level of income. This level of income for a given participant may be stated as a percentage of current salary (“income replacement”). By means of standard and well-known projection techniques, a determination can be made, based on the participant's current account balance, how the participant has that balance invested, projected inflation rate, assumed rate of salary increases, the rate at which additional contributions are being made to the participant's account, how such additional contributions are invested, projected rates of return on the participant's various investments, and the participant's current age and expected or predicted age at retirement, as to whether the desired level of income replacement is likely to be attained. Other factors can also be taken into account, such as common or recommended changes in investment strategy over time, to reflect the possibility that a participant will, over time, gradually shift from a relatively aggressive diversification of investments to a more conservative one as retirement approaches.

Another goal may be to attain a certain level of participation in the retirement plan. For example, if only 10% of all eligible employees actually participate, the sponsor may feel that the retirement plan is not serving its full purpose, even if the participants happen to be participating actively and are on track to be able to retire with the desired level of income replacement. The same is true if a substantial percentage of eligible employees participate but make contributions at a very low rate, or have their balances invested in ways that produce very low rates of return (for example, entirely in money markets and bonds). The sponsor will wish to see wide participation and effective management of the participants' accounts, so that the sponsor's employees are getting the full benefit of the retirement plan.

Also, if participation is rather low, or if for any other reason the retirement plan does not appear likely to produce the desired results for employees, it will serve less effectively than desired as a reason to join and remain at the employer. Since the sponsorship and administration of a retirement plan involve significant expense to the plan sponsor, it is naturally desirable for the sponsor to obtain the maximum benefit from the plan, by its employees' obtaining the maximum benefit. Additionally, institutional and other large shareholders may regard having a highly effective retirement plan, rather than a relatively unproductive one, as an expected indication of good management.

Once the goals have been defined, then in step 204, specified information, discussed below, is gathered by the plan sponsor, or on the sponsor's behalf. In step 206, the gathered information is analyzed to produce a “snapshot” of the current operation of the retirement plan. This “snapshot” may include statistics reflecting the operation of the retirement plan, and when the analysis is performed using the process of the present invention, it includes the calculated values of certain parameters for the purpose of permitting the user to formulate a high-level and yet thorough evaluation of the current performance or health of the retirement plan.

Based on the “snapshot”, the plan sponsor in step 208 evaluates the current health of the retirement plan. If the retirement plan seems likely to miss one or more of the sponsor's stated goals, the sponsor identifies possible trouble areas, or factors that may over time tend to reduce the efficacy of the plan, and produces a set of strategies (which hereinafter is termed a “plan for success”, to distinguish it from the retirement plan itself) for improving the ability of the retirement plan to meet its goals going forward. In step 210, the sponsor implements this plan for success.

Once the plan for success has been implemented, or while it is being implemented, the sponsor in step 212 again gathers information similar to that gathered in step 204, and in step 214 subjects the current information to analysis similar or identical to that in step 206. Using the present invention, this produces values or parameters, which typically will be identical to the set of parameters whose values were generated in step 208, that reflect how well the retirement plan is now meeting its goals. In step 216, the sponsor evaluates the progress made. The sponsor in this way also gains insight into possible weaknesses in the plan for success, and based on this insight decides in step 218 whether to revise the plan for success. Any such revision is made and implemented in step 220. If such a revision is made, then the sponsor will repeat steps 212 through 216, to obtain feedback on the effectiveness of the revisions that have been made. Even if no revision is made, however, steps 212 through 218 are performed as many times as the sponsor deems useful, so as to provide the sponsor with an on-going overall view of the progress being made.

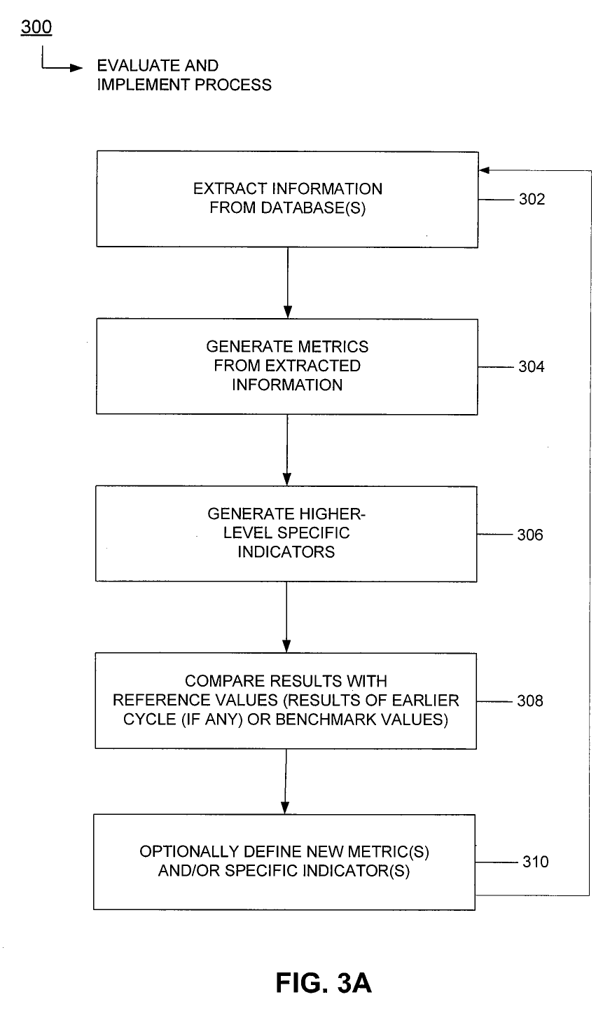

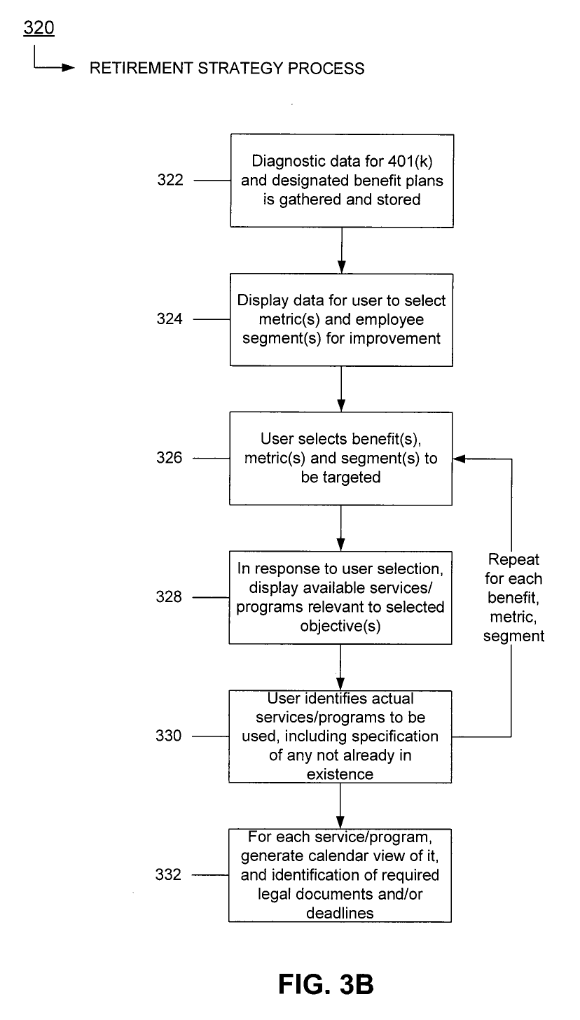

Referring to FIG. 3, a flowchart illustrating a retirement plan evaluation and diagnostic process 300, according to the present invention, is shown.

Process 300 begins at step 302, in which specified information is extracted from the appropriate database(s) by processor 104, and in step 304, is processed by processor 104 to generate values for a number of parameters. The parameters in question include various metrics that help show which groups of employees are participating or not participating in the plan, and their current patterns of contribution and of investment. The parameters also include a smaller number of higher-level specific indicators, which are computed by processor 104 from the metrics in step 306. These specific indicators together provide a multi-dimensional picture of the overall health of the retirement plan, that is, to what degree the plan is currently doing what it is intended to do.

The metrics used in the embodiments illustrated herein include the following:

E, the count of employees eligible to participate in the retirement plan;

P, the count of employees who are actually participating in the retirement plan (“participants”);

C, the count of participants who are contributing to their accounts in the retirement plan at a rate above a threshold value X, which may exemplarily be 6% of gross salary;

F, the count of participants who meet specific criteria to be deemed “active participants”, for example, having in their accounts at least three different funds, or at least one fund whose holdings are sufficiently diverse, such as an American Express Lifestyle fund;

Adiv, an indicator of the level of diversification of the holdings in the accounts of the participants;

Adef, the average deferral rate of the participants measured as a percentage of annual compensation;

Ldef, the count of participants who are deferring less than a set threshold Y, for example, 6%;

NInvCrit, a count of participants who do not meet specified investment criteria;

Tar1, a count of participants deemed active, but who are deferring less than threshold value Y and contributing less than threshold value X; and

Tar2, a count of participants included in the count of Tar1 who have a very low deferral rate, falling below a threshold value Z, e.g. 4%.

The success indicators, or specific indicators, used in the illustrated embodiments include:

P/E, the ratio of those participating in the retirement plan to all those eligible to do so;

C/E, the ratio of those participants in the retirement plan whose contribution rates are above threshold value X to the total number of employees eligible to participate;

F/E, the ratio of those participants in the retirement plan whose account investments are deemed sufficiently diversified, to the total number of employees eligible to participate;

X/E, the ratio of those participants in the retirement plan whose contribution rates are above threshold value X and whose account investments are deemed sufficiently diversified, to the total number of employees eligible to participate; and

OT, a percentage of participants who are on track for a financially secure retirement.

It is to be understood that the use of other metrics and of other specific indicators is also within the scope of the present invention.

In the illustrated embodiment, the metrics can be generated from data relating to all the employees of the sponsor, but they can also be generated for specified subsets of the employees. For this purpose, the employees can be divided by age group, by salary, by years of tenure with the company, and by location of employment. The age groups used, in the illustrated embodiment, are: under 25, 25-34, 35-44, 45-54, 55-64, and 65 or over. By way of example, the salary ranges used in this embodiment are, in thousands of dollars per annum: less than 30; 30-45; 45-60; 60-75; 75-90; 90-110; 110-130; 130-150; and over 150.

Again, it is to be understood that these age groups, salary ranges, etc., can be varied without departing from the scope of the present invention.

Based on these detailed metrics, the sponsor can identify particular subsets of employees whose rate or level of participation in the retirement plan is lower than desired, for the purpose of designing educational efforts directed specifically or especially at those employees. For example, if the metrics reveal that only 12% of all employees between 35 and 44 years of age who are employed at the sponsor's facility in a particular city are participants in the retirement plan, the sponsor can implement an educational program at that facility, aimed particularly at employees in that age group. The present invention also includes steps to assist the sponsor in this, as described below with reference to FIG. 3B.

Thus, process 300 of the present invention delivers to the sponsor a “snapshot” of the state of the retirement plan, providing the sponsor with a way to see what is as desired and what can be improved on. Once the sponsor has made any changes to the retirement plan it considers advisable, and has devised and implemented a plan for success as mentioned above (to make such improvements as appear necessary to the various aspects of the operation of the retirement plan), steps 302 through 306 are repeated by processor 104 one or more times. After each repetition, or cycle, of these steps, processor 104 performs a comparison in step 308 between at least some of the metric values and specific-indicator values obtained in the most recent repetition and the values of the same metrics and the same specific indicators in one, several or all of the preceding executions of steps 302 through 306. In the illustrated embodiment, this comparison includes not only the visual presentation of both cycles' results side by side, but also the calculation and presentation of the amount of each cycle-to-cycle change, either as a percentage or otherwise. Alternatively, the comparison may be presented in the form of graphs, and of course both types of presentation can be utilized.

The results of this comparison are presented to the sponsor in any form that is convenient, including by means of the user interface, and (more commonly) as a hard printout or an electronic file that is sent, or otherwise made available to, the appropriate persons.

In addition, the comparison results may include not only the values of the metrics and of the specific indicators at the times of the two or more “snapshots” in question, but also (or alternatively) a comparison of the most recent values of these parameters with target values set in the plan for success, with or without a computation and display of the amount by which the target value is exceeded or missed. (It is to be understood that in a particular instance, it may be that no specific target values have been set.) Alternatively, or in addition, benchmark figures that are not specific to the plan sponsor may be shown in the comparison.

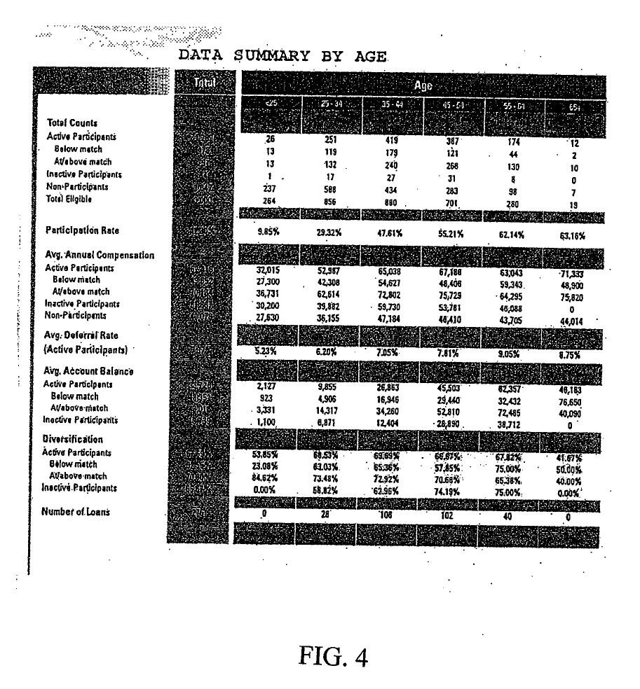

In FIGS. 4 through 20, screens or printouts showing the results of execution of steps 306 and 308 are shown.

In FIG. 4, participation levels are shown, and for active participants, the average annual compensation, average deferral rate, average account balances, diversification levels and number of outstanding loans taken by participants, are shown. In FIG. 4, the numbers shown are broken down by age group, using the age cohorts defined above. The figures indicating “below match” and “at/above match” indicate the numbers of active participants whose own contributions are respectively below, or at or above, the maximum levels that will be matched by the employer, in the particular illustration shown.

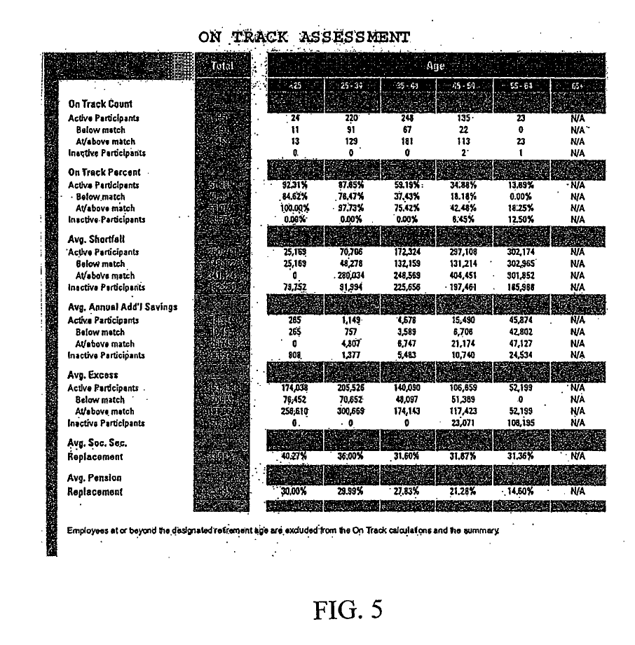

In FIG. 5, for each group identified in FIG. 4, the percentage of active participants in the group deemed to be doing what they need to do to be considered on track for a financially secure retirement is given.

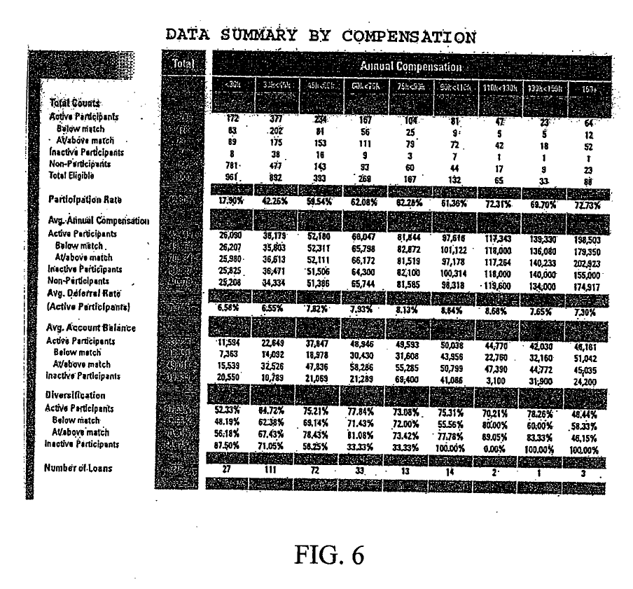

In FIG. 6, information is shown in a fashion similar to that of FIG. 4, except that the data are broken down according to compensation ranges and not by age group.

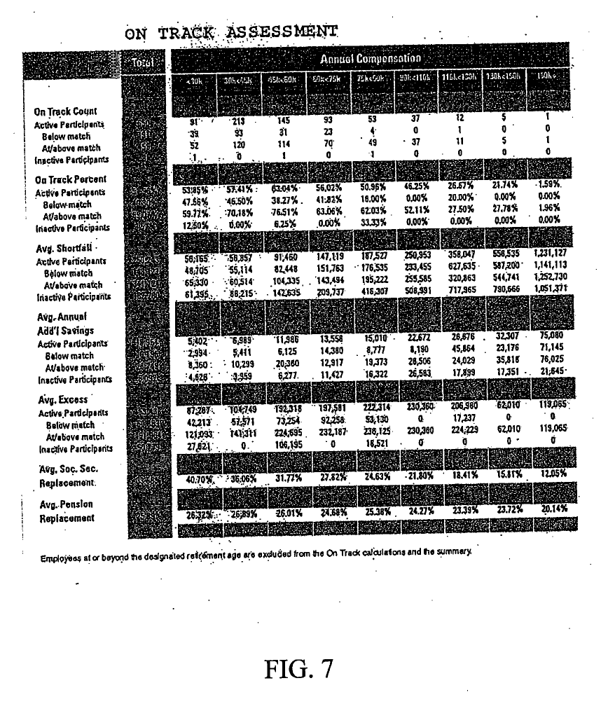

In FIG. 7, for each group identified in FIG. 6, the percentage of active participants in the group deemed to be doing what they need to do to be considered on track for a financially secure retirement is given.

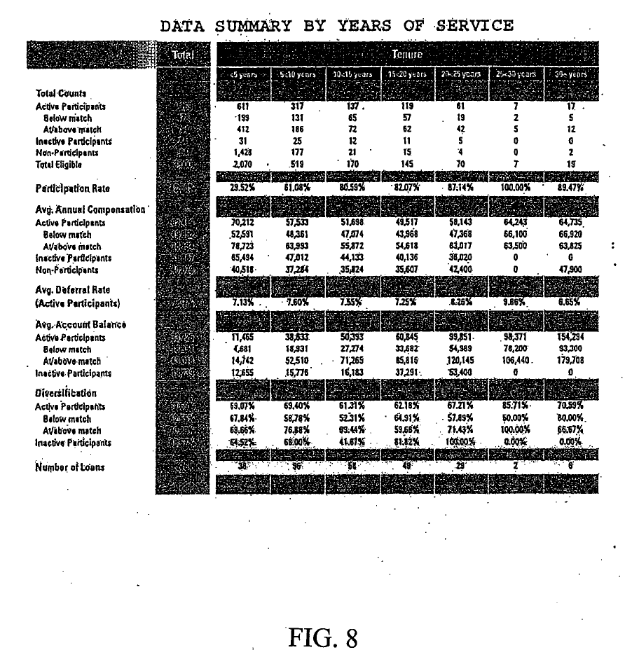

In FIG. 8, information is shown in a fashion similar to that of FIG. 4, except that the data are broken down according to the participants' years of service (tenure) with the plan sponsor and not by age group.

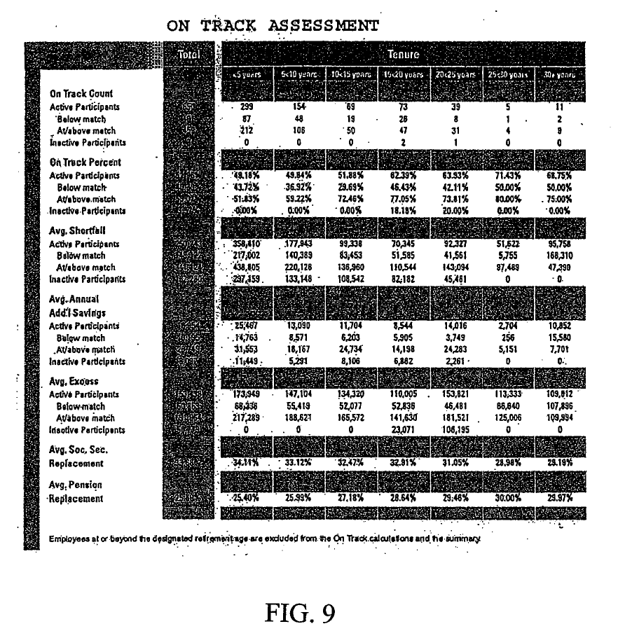

In FIG. 9, for each group identified in FIG. 8, the percentage of active participants in the group deemed to be doing what they need to do to be considered on track for a financially secure retirement is given.

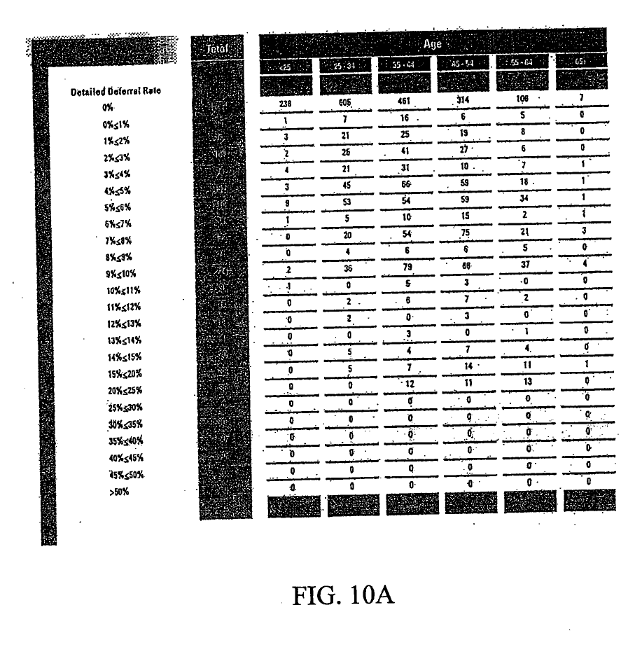

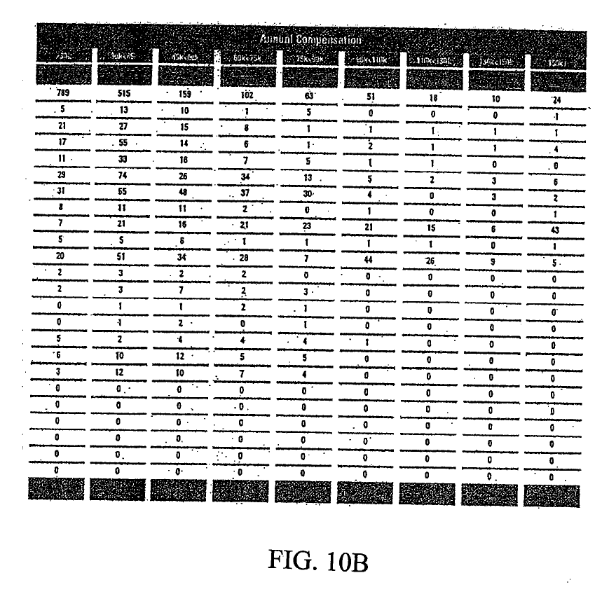

In FIGS. 10a and 10b, which together form a single screen, a detailed breakdown of deferral rate against age group (in FIG. 10a) and against compensation range (in FIG. 10b) is shown.

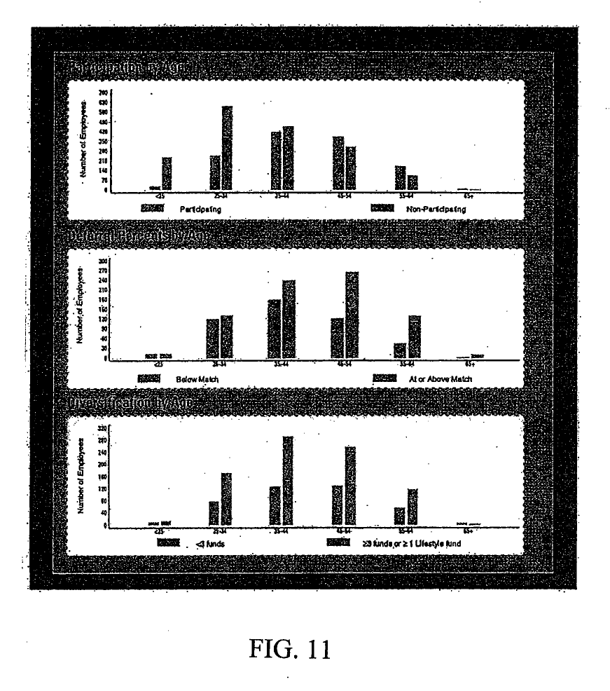

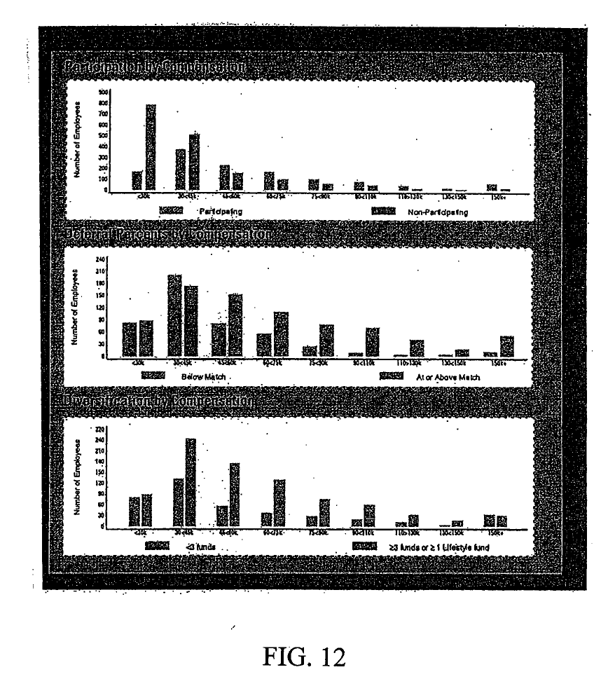

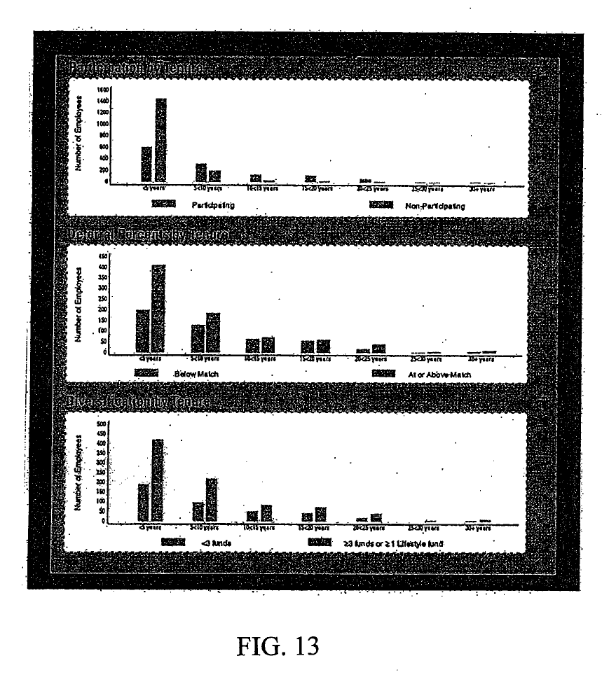

FIGS. 11 through 13 show summaries of participation, deferral levels and diversification, by age (in FIG. 11), by compensation range (in FIG. 12) and by tenure (in FIG. 13).

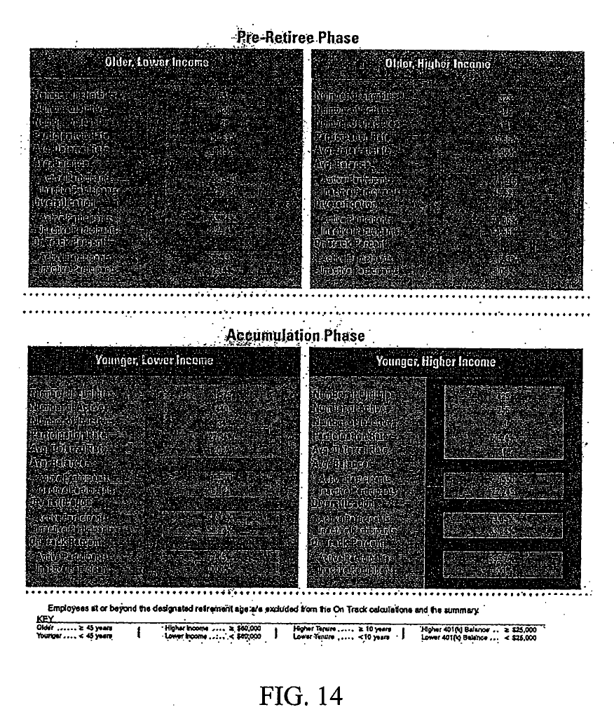

FIG. 14 shows a demographic map, representing an integration of two characteristics, age and income, that are demographic identifiers over which individuals have incomplete or no control. This Figure provides more definition around what is happening with individuals in the accumulation and the pre-retiree phases of preparing for retirement.

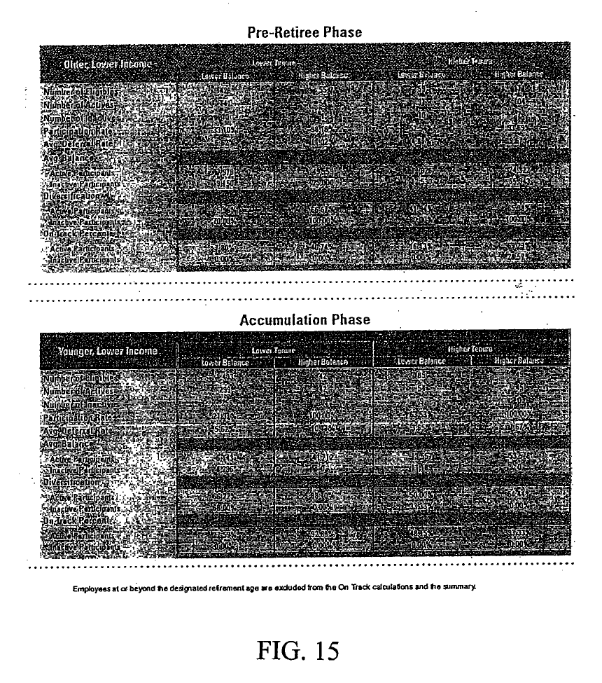

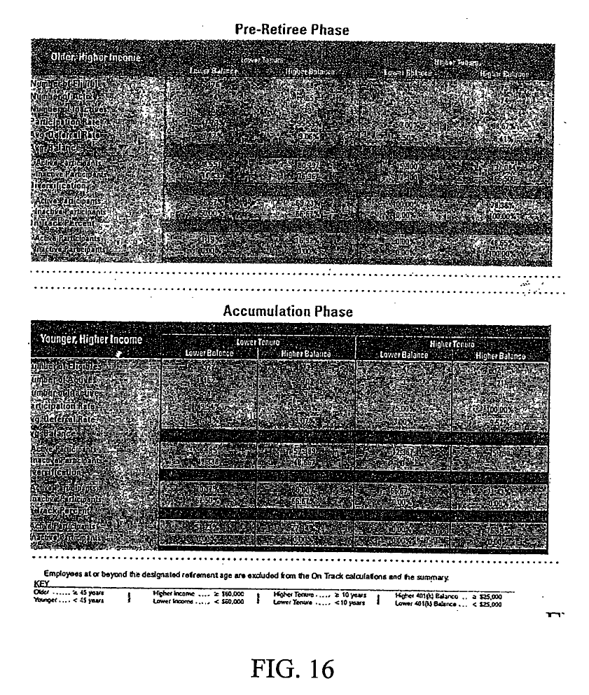

FIGS. 15 and 16 show a behavioral map, also representing an integration of two segmentation characteristics, but two which are more easily controlled by the employee, tenure and account balance. This map identifies 16 segments that align with behavioral profiles and indicate that these segments are logical ones to which targeted programs intended to influence employee behavior can be directed. Specifically, this map segments employees along each of four axes: older versus younger, higher income versus lower income, longer tenure versus shorter tenure, and higher account balance versus lower account balance, the 16 possible combinations of these attributes defining the mentioned 16 segments.

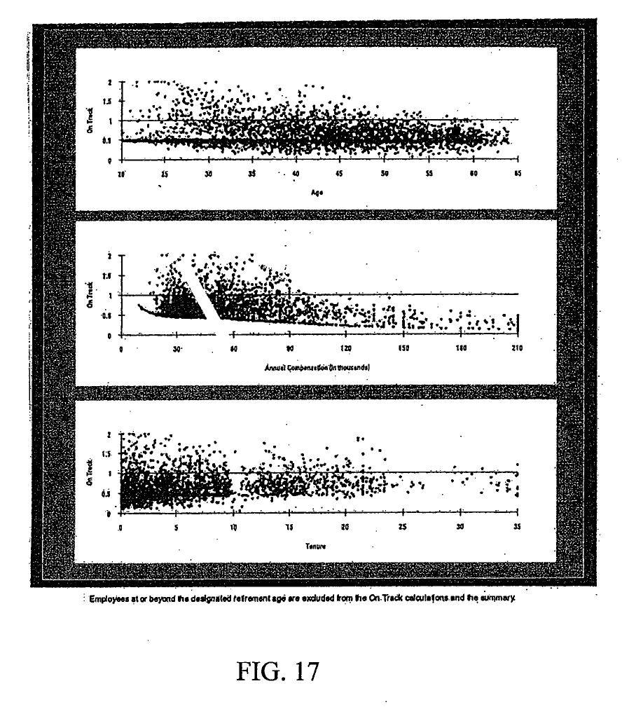

FIG. 17 shows scattergrams that graphically show on-track indicators versus age, annual compensation, and tenure.

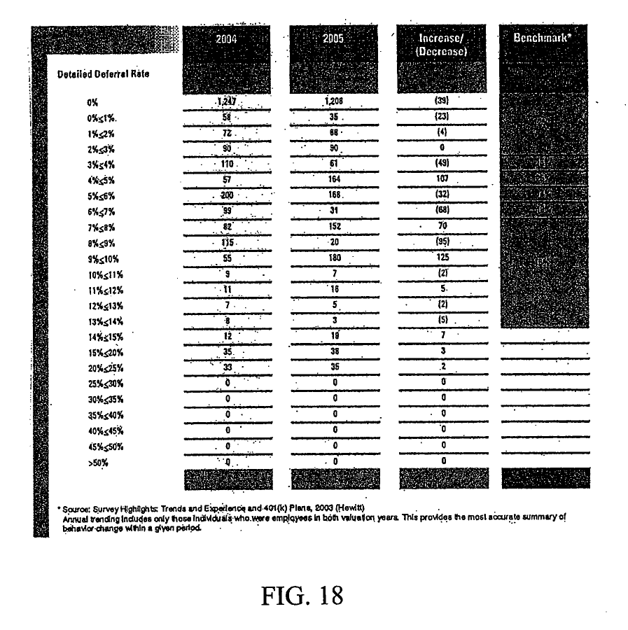

FIG. 18 shows a comparison of breakdowns for detailed deferral rate as between two times, 2004 and 2005, as well as the increase or decrease. Benchmark figures are also shown.

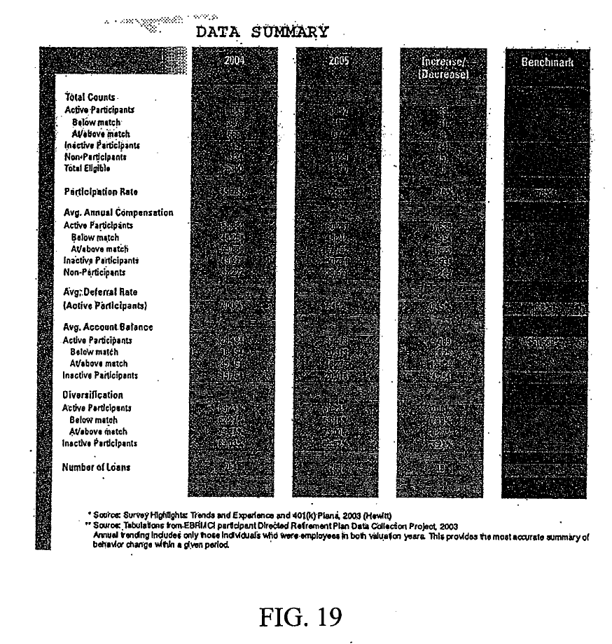

FIG. 19 shows a data summary relating to active participation, participation below or at least at match level, and average annual compensation, account balance and diversification level for each group. Again, a comparison is shown between 2004 and 2005, with the increase and decrease for each metric, and with benchmark figures given as well.

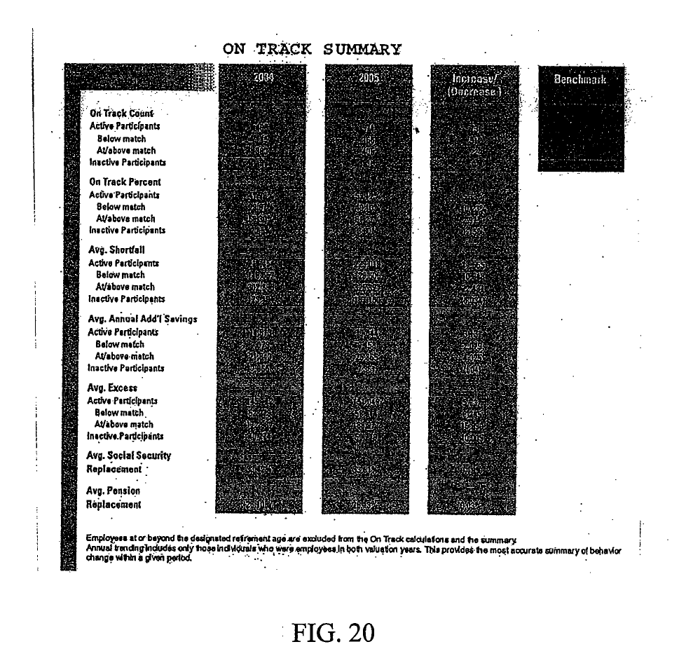

FIG. 20 shows a summary of participants in various groups and subgroups who are on track for a financially secure retirement. A comparison between the figures for 2004 and 2005 is shown, along with the increase or decrease for each indicator.

In the examples shown in FIGS. 4 through 20, the same metrics and specific indicators have been used for both cycles, where two cycles are illustrated. It may occur that after an evaluation cycle, the sponsor will wish to define a new metric or specific indicator. Accordingly, in step 310, instructions can be received to add a definition of such new metric(s) and specific indicator(s) for use in the next evaluation cycle, as well as the processing necessary to determine the value(s) of these new parameters from the data extracted in step 302. Referring to FIG. 3B, a flow chart illustrating a further portion of process 300 is shown.

In this portion, which is the retirement strategy process 320, the present invention provides assistance to the plan sponsor in formulating a plan for success. In step 322, the diagnostic data is gathered into a database (which may be databases 152 and 154, or another database). This data relates to employees' 401(k) holdings, and any vested interests they may have in a designated benefits plan, either offered by the plan sponsor or from previous employment. In step 324, processor 104 displays (or prints out, if desired) metrics and related data, for example in a format similar to the screens shown in FIGS. 4-20, or in other formats, to allow the user to identify which metrics and which employee segments represent the best opportunities for improvement. It is within the scope of the present invention that processor 104 compares the metrics against predetermined values, with or without reference to other data, and itself identifies various metrics and/or employee segments as representing opportunities of possible interest, and provides these identifications to the user for the user's consideration.

In step 326, processor receives the user's selection of benefit(s), metric(s) and/or employee segment(s) to be targeted for improvement, and in step 328, processor 104 retrieves and provides to the user a selection of existing services and programs suitable for addressing the identified target benefit(s), metric(s) and employee segment(s). By “services and programs” is meant educational programs, and it is contemplated that in many instances, such a program suitable for addressing the identified target may already exist, since a similar employee segment (for example) may have been the object of a similar program in the past. It should be noted, also, that these services and programs need not relate only to the employees' participation in and holdings in the sponsor's own retirement plan, but may also address employees' other holdings, including in their 401(k), defined benefit or IRA accounts. This is because in some instances it may be that improved management of an employee's existing retirement assets not in the sponsor's retirement plan may assist significantly in putting the employee on target for a financially secure retirement.

In step 330, the user provides computer system 100 with specifications of any modifications being made to the existing service/program(s) selected by the user, as well as specifications of any newly devised service/program, and processor 104 retrieves, based on these specifications, information that is then provided to the user, showing a calendar view of the service/program(s), and a list of any legal documents and/or deadlines that may be required in conjunction with implementing the identified or specified service/program(s). This assists the user in ensuring that all necessary legal requirements are fulfilled, and in a timely fashion.

The data gathered in step 302 relates to the sponsor's employees and their participation in the sponsor's retirement plan. Typically, however, employees will have become entitled to Social Security benefits once they have retired, and once they have reached the age specified by the Social Security system. Additionally, some employees may have vested rights in one or more other retirement plans, IRAs, or other types of retirement accounts. These additional benefits and assets may have a significant impact on the participants' financial condition upon their eventual retirement, and in the illustrated embodiment, therefore, it is also contemplated to gather the relevant available data relating to Social Security and other additional benefits and assets.

Again, while it is contemplated that step 302 will ordinarily be executed to gather information that is at least substantially current, thus providing a current “snapshot” of the operation of the retirement plan, it is also within the scope of the present invention to gather information from a specified time in the past. A comparison of the metrics and specific indicators determined from such historical information with current values may provide the sponsor with useful insights, such as providing a way to measure the success of earlier educational efforts made in the past. This insight into what kinds of educational efforts have succeeded previously, and with which groups of employees, may be of use in designing effective efforts in the present.

Again, step 302 may include gathering data pertaining not only to employees who are currently eligible to be participants, but to all employees. Where this is done, execution of step 304 does not use data about ineligible employees in determining the metric and specific-indicator values, but by obtaining counts of employees who are not yet eligible, by age group, salary level, location, etc., the sponsor can identify groups of employees likely to become eligible in the near or mid-term future, and if significant numbers of such employees are similar in age, salary level, etc., to one or more groups of eligible employees who do not participate in the retirement plan, or do so only at a low level of contribution or the like, then educational efforts aimed at these employees who are not yet eligible may also aid the sponsor in improving the effectiveness of the retirement plan once those employees do become eligible. Additional useful information may also be obtained if data is available about any such employees' entitlement to or vesting in benefits or assets in the Social Security system or other retirement accounts.

As described above, the process 300 of the present invention includes step 308, in which a comparison is executed between the parameter values obtained in two or more evaluation cycles, or between the parameter values obtained from one cycle with target values or benchmark values, and the benefits of using the present invention will be maximized by including step 308. Nonetheless, it is within the scope of the present invention to determine parameter values from just a single time, showing the operation and the overall health of the retirement plan at that time.

Example Implementations

The present invention (i.e., system 100, process 300 or any parts or functions thereof) may be implemented using hardware, software or a combination thereof and may be implemented in one or more computer systems or other processing systems. However, the manipulations performed by the present invention were often referred to in terms, such as analyzing or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general-purpose digital computers or similar devices.

Computer programs (also referred to as computer control logic) are stored in main memory 108 and/or secondary memory 110. Computer programs may also be received via communications interface 124. Such computer programs, when executed, enable computer system 100 to perform the features of the present invention, as discussed herein. In particular, the computer programs, when executed, enable processor 104 to perform the steps of process 300 of the present invention. Accordingly, such computer programs represent controllers of computer system 100.

In an embodiment where the invention is implemented using software, the software may be stored in a computer program product and loaded into computer system 100 using removable storage drive 114, hard drive 112 or communications interface 124. The control logic (software), when executed by processor 104, causes processor 104 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

Conclusion

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures and screen shots illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

We claim:

1. A computer-implemented method for evaluating the performance of specified goals in a retirement plan, comprising the steps of:
extracting data that reflects participation in said retirement plan at a specified time during existence of said retirement plan, said data including information relating to contributions to said retirement plan, and investment results of said retirement plan during a time period in said existence of said retirement plan;
generating first parameter values indicative of how well said retirement plan is fulfilling specified goals at said specified time, using said extracted data;
repeating said extracting and said generating steps, after a predetermined period of time, in order to produce second parameter values indicative of how well said retirement plan is fulfilling said specified goals; and
comparing said second parameter values with reference values in order to produce an indication of how well said retirement plan is performing.

2. The method of claim 1, wherein said parameter values generated in said generating step includes metrics whose values are indicative of various aspects of performance of said retirement plan.

3. The method of claim 2, wherein said parameter values generated in said generating step further includes indicators that are derived from said metrics and whose values are indicative of how closely said retirement plan approaches desired levels of performance.

4. The method of claim 2, wherein said metrics include one or more selected from the group consisting of:
E, a count of employees eligible to participate in the retirement plan;
P, a count of employees who are actually participating in said retirement plan (“participants”);
C, a count of participants who are contributing to their accounts in said retirement plan at a rate above a set threshold value;
F, a count of active participants;
Adiv, an indication of diversification of holdings in said accounts of said participants;
Adef, an average deferral rate of said participants;
Ldef, a count of said participants who are deferring less than a set threshold Y;
NInvCrit, a count of said participants who do not meet specified investment criteria;
Tar1, a count of said participants deemed active, but who are deferring less than threshold value Y and contributing less than threshold value X; and
Tar2, a count of said participants included in a count of Tar1 who have a deferral rate below a threshold value Z that is lower than Y.

5. The method of claim 3, wherein the metrics include two or more selected from the group consisting of:
E, a count of employees eligible to participate in said retirement plan;
P, a count of employees who are actually participating in said retirement plan (“participants”);
C, a count of participants who are contributing to their accounts in the retirement plan at a rate above a set threshold value;
F, a count of active participants;
Adiv, an indication of diversification of the holdings in accounts of said participants;
Adef, an average deferral rate of said participants;
Ldef, a count of participants who are deferring less than a set threshold Y;
NInvCrit, a count of participants who do not meet specified investment criteria;
Tar1, a count of participants deemed active, but who are deferring less than threshold value Y and contributing less than threshold value X; and
Tar2, a count of participants included in the count of Tar1 who have a deferral rate below a threshold value Z that is lower than Y; and
wherein the indicators include one or more selected from the group consisting of:
P/E, P divided by E,
C/E, C divided by E,
F/E, F divided by E,
X/E, a ratio of those participants in said retirement plan whose contribution rates are above threshold value X and whose account investments are deemed sufficiently diversified, to a total number of employees eligible to participate, and
OT, a percentage of participants who are on track for a financially secure retirement.

6. The method of claim 1, wherein the information extracted in said extraction step includes information reflecting retirement benefits and/or assets to which participants of said retirement plan have become entitled other than through said retirement plan.

7. The method of claim 1, wherein said reference values used in said comparing step includes at least some of said first set of parameter values, and said comparing step produces an indication of the change in how well said retirement plan is performing from said specified time to after said predetermined period of time.

8. The method of claim 1, wherein said reference values used in said comparing step includes at least one of benchmark values and target values.

9. The method of claim 1, further comprising the step of: selecting, in response to a user identifying at least one benefit, metric and/or employee segment which it is desired to target for improvement of the performance of the retirement plan, an existing service and/or program directed to the improvement of that at least one benefit, metric and/or employee segment.

10. The method of claim 9, further comprising the step of: generating, in response to a user designating a service/program, a calendar view of acts to be performed in executing the service/program, and a list of any required legal documents and of any applicable legal deadlines that must be met in executing the service/program.

11. A system for evaluating the performance of specified goals in a retirement plan, comprising:
a means for extracting data that reflects participation in said retirement plan at a specified time during the existence of said retirement plan, said data including information relating to contributions to said retirement plan, and investment results of said retirement plan during at least a specified time-period of said existence of said retirement plan;
a means for generating a first set of parameter values indicative of how well said retirement plan is fulfilling said specified goals using data extracted at a first time, and for generating a second set of parameter values indicative of how well said retirement plan is fulfilling said specified goals using data extracted at a second time; and
a means for comparing said second set of parameter values with a set of reference values in order to produce an indication of how well said retirement plan is performing.

12. The system of claim 11, wherein parameter values generated by said means for generating include metrics whose values are indicative of various aspects of said performance of said retirement plan.

13. The system of claim 12, wherein said parameter values generated by said means for generating also include indicators that are derived from said metrics and whose values are indicative of how closely said retirement plan approaches desired levels of performance.

14. The system of claim 12, wherein said metrics include one or more selected from the group consisting of:
E, a count of employees eligible to participate in said retirement plan;
P, a count of employees who are actually participating in said retirement plan (“participants”);
C, a count of participants who are contributing to their accounts in said retirement plan at a rate above a set threshold value;
F, a count of active participants;
Adiv, an indication of diversification of holdings in accounts of participants;
Adef, an average deferral rate of said participants;
Ldef, a count of participants who are deferring less than a set threshold Y;
NInvCrit, a count of participants who do not meet specified investment criteria;
Tar1, a count of participants deemed active, but who are deferring less than threshold value Y and contributing less than threshold value X; and
Tar2, a count of participants included in the count of Tar1 who have a deferral rate below a threshold value Z that is lower than Y.

15. The system of claim 13, wherein said metrics include two or more selected from the group consisting of:
E, a count of employees eligible to participate in said retirement plan;
P, a count of employees who are actually participating in said retirement plan (“participants”);
C, a count of participants who are contributing to their accounts in said retirement plan at a rate above a set threshold value;
F, a count of active participants;
Adiv, an indication of diversification of holdings in accounts of participants;
Adef, an average deferral rate of said participants;
Ldef, a count of participants who are deferring less than a set threshold Y;
NInvCrit, a count of participants who do not meet specified investment criteria;
Tar1, a count of participants deemed active, but who are deferring less than threshold value Y and contributing less than threshold value X; and
Tar2, a count of participants included in the count of Tar1 who have a deferral rate below a threshold value Z that is lower than Y; and
wherein the indicators include one or more selected from the group consisting of:
P/E, P divided by E,
C/E, C divided by E,
F/E, F divided by E,
X/E, the ratio of those participants in the retirement plan whose contribution rates are above threshold value X and whose account investments are deemed sufficiently diversified, to a total number of employees eligible to participate, and
OT, a percentage of participants who are on track for a financially secure retirement.

16. The system of claim 11, wherein said set of reference values used by said means for comparing includes at least some of said first set of parameter values, and said means for comparing produces an indication of the change in how well said retirement plan is performing as between said first time and said second time.

17. The system of claim 11, wherein said set of reference values used by said means for comparing includes at least one of benchmark values and target values.

18. The system of claim 1, wherein said information extracted by said means for extracting includes information reflecting retirement benefits and/or assets to which participants of said retirement plan have become entitled other than through said retirement plan.

19. A computer program product comprising a computer usable medium having control logic stored therein for causing a computer to evaluate performance of specified goals in a retirement plan, said control logic comprising:
first computer readable program code means for causing said computer to extract data that reflects participation in said retirement plan at a specified time during existence of said retirement plan, said data including information relating to contributions to said retirement plan, and investment results of said retirement plan during at least a specified time-period of said existence of said retirement plan;
second computer readable program code means for causing said computer to generate a first set of parameter values indicative of how well said retirement plan is fulfilling said specified goals using said data;
third computer readable program code means for causing said computer to repeat execution of said first and second computer readable program code means, after a predetermined period of time, in order to produce a second set of parameter values indicative of how well said retirement plan is fulfilling said specified goals; and,
fourth computer readable program code means for causing said computer to compare said second set of parameter values with a set of reference values in order to produce an indication of how well said retirement plan is performing.

20. The computer program product of claim 19, wherein said parameter values generated by execution of said second computer readable program code means include metrics whose values are indicative of various aspects of the performance of said retirement plan.

21. The computer program product of claim 28, wherein said parameter values generated by execution of said second computer readable program code means also include indicators that are derived from said metrics and whose values are indicative of how closely said retirement plan approaches desired levels of performance.

22. The computer program product of claim 20, wherein said metrics include one or more selected from the group consisting of:
E, a count of employees eligible to participate in said retirement plan;
P, a count of employees who are actually participating in said retirement plan (“participants”);
C, a count of participants who are contributing to their accounts in said retirement plan at a rate above a set threshold value;
F, a count of active participants;
Adiv, an indication of diversification of the holdings in the accounts of said participants;
Adef, an average deferral rate of said participants;
Ldef, a count of participants who are deferring less than a set threshold Y;
NInvCrit, a count of participants who do not meet specified investment criteria;
Tar1, a count of participants deemed active, but who are deferring less than threshold value Y and contributing less than threshold value X; and
Tar2, a count of participants included in the count of Tar1 who have a deferral rate below a threshold value Z that is lower than Y.

23. The computer program product of claim 21, wherein said metrics include two or more selected from the group consisting of:
E, a count of employees eligible to participate in said retirement plan;
P, a count of employees who are actually participating in said retirement plan (“participants”);
C, a count of participants who are contributing to their accounts in said retirement plan at a rate above a set threshold value;
F, a count of active participants;
Adiv, an indication of diversification of the holdings in the accounts of said participants;
Adef, the average deferral rate of said participants;
Ldef, a count of participants who are deferring less than a set threshold Y;
NInvCrit, a count of participants who do not meet specified investment criteria;
Tar1, a count of participants deemed active, but who are deferring less than threshold value Y and contributing less than threshold value X; and
Tar2, a count of participants included in the count of Tar1 who have a deferral rate below a threshold value Z that is lower than Y; and
wherein indicators include one or more selected from the group consisting of:
P/E, P divided by E,
C/E, C divided by E,
F/E, F divided by E,
X/E, the ratio of those participants in said retirement plan whose contribution rates are above threshold value X and whose account investments are deemed sufficiently diversified, to a total number of employees eligible to participate, and
OT, a percentage of participants who are on track for a financially secure retirement.

24. The computer program product of claim 19, wherein information extracted by execution of said first computer readable program code means includes information reflecting retirement benefits and/or assets to which participants of said retirement plan have become entitled other than through said retirement plan.

25. The computer program product of claim 19, wherein said set of reference values used in execution of said fourth computer readable program code means includes at least some of said first set of parameter values, and execution of said fourth computer readable program code means produces an indication of change in how well said retirement plan is performing from said specified time to after said predetermined period of time.

26. The computer program product of claim 19, wherein said set of reference values used in execution of said fourth computer readable program code means includes at least one of benchmark values and target values.
